(19) United States
(12) Patent Application Publication
(10) Pub. No.: US 2008/0009399 A1
(43) Pub. Date: Jan. 10, 2008

(54) Machine And Method For Forming Tubes By Helical Winding Of Strips Of Web Material

(75) Inventors: Mauro Gelli, Lucca (IT); Giancarlo Cicalini, Lucca (IT); Graziano Mazzaccherini, Lucca (IT)

Correspondence Address: BREINER & BREINER, L.L.C., P.O. BOX 320160, ALEXANDRIA, VA, 22320-0160, US

(73) Assignee: Fabio Perini S.P.A., Lucca (IT)

(21) Appl. No.: 11/791,168

(22) PCT Filed: Nov. 18, 2005
(86) PCT No.: PCT/IT05/00672

§ 371 Date: May 21, 2007

(30) Foreign Application Priority Data
Nov. 22, 2004 (IT) FI2004A000241

(51) Int. Cl. B31C 3/04

(52) U.S. Cl. 493/272; 493/269

(57) ABSTRACT

The invention relates to a machine for producing tubular articles (T) by helical winding of strips of web material, comprising a spindle (4) and a winding member (7) to helically wind the strips (S1, S2) of web material around the spindle. To improve adhesion between strips pressure is applied to the overlapping turns of strips of web material by an ultrasonic generator (33).

### TECHNICAL FIELD

The present invention relates to a corewinder, i.e. a device used to produce tubular articles from strips of web material which are wound helically around a spindle and glued to form the finished product.

The invention also relates to a method for producing tubular articles of the aforesaid type.

### STATE OF THE ART

When producing rolls of web materials, such as rolls of toilet paper, kitchen towels, non-woven fabric, adhesive tape, plastic film, metallized film or the like, tubes of cardboard or other materials, obtained by overlapping and staggered winding of at least two strips of web material glued together, are commonly used as winding cores. Winding is performed by machines known as corewinders and which have a forming spindle (fixed or supported idle about the axis thereof) around which strips of web material, previously provided with a layer of glue, are wound. Usually, winding is obtained by means of a winding member, typically a continuous belt which forms a helical turn around the spindle and causes drawing and winding of the strips of web material. The winding member provides the thrust to the helically wound strips, to form the tubular article and feed it along the winding spindle.

Examples of machines of this type are described in U.S. Pat. Nos. 2,489,503; 3,150,575; 3,220,320; 3,636,827; 3,942,418; 5,468,207; 5,873,806. Other examples of corewinders are described in JP-A-59-9044; AU-A-30, 210/67.

The strips of web material are wound continuously and form a continuous tube which is then cut into sections of the required length by means of cutting members positioned along the tube being formed.

The width of the continuous belt used to obtain winding of the turns of web material is less than the width of the strips of said material. The purpose of this is to prevent the glue, seeping along the edges of the turns due to the pressure exerted by the belt, from soiling said belt. This means that in the very area in which there is greater need, the pressure exerted is insufficient to obtain reciprocal adhesion of the overlapping turns of the two or more strips forming the tube.

One of the problems encountered in the production and subsequent use of these tubes consists in the fact that the quality of the gluing between helical strips of web material is not always sufficient to maintain the integrity of the tube. In fact, the tubular article can break while running along the forming spindle if gluing is insufficient to stabilize the turns being formed thereon. Another critical point during forming of the tubular articles is encountered in the area in which the continuous tubular article is cut into sections. Problems related to grip of the glue can also occur in this area resulting in localized disintegration or breaking of the product.

Even when the product is delivered from the corewinder in one piece, imperfect gluing of the strips of which it is formed can give rise to further drawbacks during use of the tubes as winding cores for rolls.

In fact, in many applications, such as the production of rolls of toilet paper or kitchen towel, the rolls wound on the tubular cores must subsequently be cut crosswise to the axis thereof into small rolls of an axial length equivalent to the axial dimension of the finished product. Drawbacks frequently occur in the cutting machines used for this purpose due to the fact that the blade performing the cut, by interfering with the strips of web material forming the tubular winding core, cause partial breakage thereof. Breakage occurs at the level of the cutting plane, where the blade intersects the edge of the innermost strip of web material. The stress applied by the blade, due to friction, causes partial detachment of the strip of web material from the inner tubular wall of the winding core. This breakage is unacceptable to manufacturers of rolls, as it has a negative influence on the aesthetic properties of the finished product. To a certain extent it can also cause a functional problem in the finished product, as it obstructs insertion into the dispensing device.

Other problems that can occur in the production of tubes are recognizable in the fact that: the poor quality of adhesion between overlapping strips makes it necessary to run the corewinder at a lower speed than its top design speed, resulting in a reduction in productivity; the tubes cannot withstand the high speeds that can be reached by the rewinding machines on which they are used; and the tubes can become damaged during storage, i.e. when they are stored between the corewinder and the rewinding machine on which they are used.

### OBJECTS AND SUMMARY OF THE INVENTION

The object of the present invention is to produce a corewinder which overcomes the aforesaid drawbacks entirely or in part and allows a tubular article to be obtained which has increased strength and in particular improved reciprocal adhesion of the helical strips of which it is formed, thereby making it possible to reach high production speeds and a more efficient production cycle.

According to a further aspect, the object of the present invention is to produce a method which, using a corewinder, allows a tubular product of greater strength to be obtained, in particular characterized by improved reciprocal adhesion of the helical strips of web material that form the tubular product.

These and further objects and advantages, which will appear clear to those skilled in the art from reading the text hereunder, are obtained in substance with a corewinder, i.e. with a machine for producing a tubular article by helically winding strips of web material, overlapping and staggered, comprising a spindle and a winding member to helically wind strips of web material around said spindle, provided with an ultrasonic generator positioned to act on the strips being wound around the spindle, to exert a pressure on the wound strips. The ultrasonic waves generated by the generator placed next to or pressed against the outer surface of the tube being formed produce an effect of localized compression on the strips. This effect can be used alone to join the strips, even without glue. When the strips are made of paper material, such as cardboard or card of suitable grammage, strong localized pressure in fact causes breakage of the fibers and localized joining through reciprocal penetration of the fibers of one strip with those of the other. If the strips contain a heat melt material, such as a thermoplastic resin, the shock waves can cause localized melting of the thermoplastic material at the interface between the two overlapping strips.

However, the corewinder can be provided with a glue dispenser which applies glue to one or more faces of the strips forming the tube, to cause reciprocal adhesion in a conventional way. In this case the shock waves produced by ultrasound apply an added localized pressure with respect to the pressure normally exerted by the belt of the winding unit or member. The pressure of the ultrasonic waves consolidates and improves adhesion and if necessary can be added to the effect of the glue.

The use of ultrasonic waves for cutting and bonding web materials is known, for example from EP-B-0790888; EP-A-1466721; US-A-2003/116291; U.S. Pat. No. 5,985,065; U.S. Pat. No. 5,989,370; WO-A-99/25547; WO-A-03/054301. Nonetheless, to date this technique has not been applied to the production of cardboard tubes or the like, by staggered helical winding of two or more strips around a forming spindle to improve reciprocal adhesion of the strips.

GB-A-1447999 describes a procedure for forming a tubular membrane filter. The filter is obtained by helically winding a single strip of non-woven fabric, so that the edges of adjacent turns are partially overlapped. A sonotrode performs sealing of the overlapping edges of the turns of the single strip of non-woven fabric, which for this purpose is formed of thermoplastic fibers. A liquid is fed between the forming spindle and the tube thus formed to form an inner membrane which completes the filter.

Also in this case, therefore, ultrasonic waves are used to join together thin plies of fibers, to obtain a tubular product with low mechanical strength, produced for a different use with respect to cardboard winding tubes for rolls of paper or the like.

According to an advantageous embodiment, the ultrasonic generator can be positioned to act prevalently on an area adjacent to the edges of one or other of the strips forming the tube and preferably along the edge or edges of the outermost strip. In this way localized concentration of the action of the ultrasonic shock waves is obtained in the area in which better and more efficient reciprocal adhesion of the strips is required, both in the case in which glue is applied and in the case in which bonding is entrusted solely to the pressure applied by the ultrasonic waves.

Advantageously, to focus the shock waves in limited areas and therefore increase the effect of pressure, the spindle around which the tube is formed can have raised areas. These raised areas can extend helically, with the same inclination as the inclination of the strips of web material wound to form the tube. This conformation prevents the raised areas from obstructing feed of the tube being formed along the spindle.

Further advantageous characteristics and embodiments of the machine according to the invention are indicated in the attached dependent claims and will be described with reference to examples of embodiment.

According to a different aspect, the invention also relates to a method for producing a tubular article wherein at least a first strip and a second strip of web material, staggered from each other, are wound helically around a winding spindle by a winding member, characterized in that ultrasonic waves are applied to the strips to cause or increase the reciprocal adhesion thereof.

Further advantageous characteristics and embodiments of the method according to the invention are indicated in the attached claims.

### BRIEF DESCRIPTION OF THE DRAWINGS

The invention will now be better understood by referring to the description hereunder and to the accompanying drawings which show a non-limiting practical embodiment of the invention. In the drawing, where the same or corresponding parts are indicated with the same reference numbers:

FIG. 1 shows a schematic side view of a machine according to the invention in a first embodiment;

FIG. 2 shows a schematic side view of a machine according to the invention in a second embodiment;

FIGS. 3 and 4 schematically show different forms of the ultrasonic transducer, or sonotrode; and

FIG. 5 shows a side and partially sectional view of an improved embodiment of the spindle of the machine according to the invention.

### DETAILED DESCRIPTION OF THE PREFERRED EMBODIMENTS OF THE INVENTION

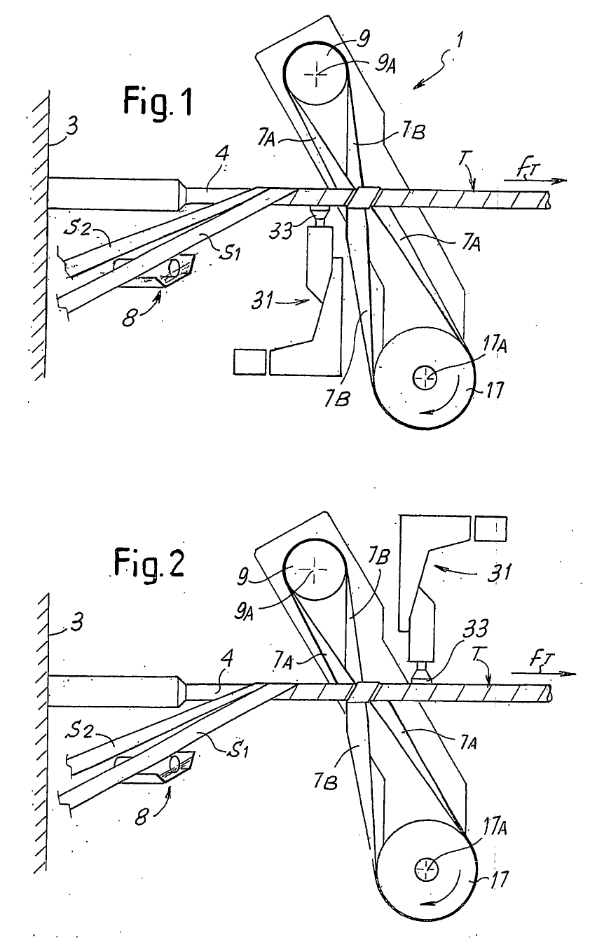

FIG. 1 shows schematically (and limited to the members essential for the description of the present invention) a corewinder to which the present invention is applied. The machine shown here only schematically could, for example, have a structure corresponding substantially to the one described in U.S. Pat. No. 5,873,806, which should be referred to for a detailed description of the components of the machine which are not involved in the description of the present invention. In particular, the cutting members of the continuous tube are not shown, and can be produced as in the aforesaid US patent, or in any other suitable way.

It must however be understood that the invention can also be applied to machines with different structures, as long as they are provided with a forming spindle to form the tubes, which can be either fixed or rotating about the axis thereof, for example mounted idle.

Briefly, and limited to the matters of interest for the present invention, the machine in FIG. 1, indicated as a whole with 1, comprises a load-bearing structure 3 from which a spindle 4 is supported projectingly, with a first end thereof connected to the load-bearing structure 3. The opposite end of the spindle 4 terminates in proximity to the cutting area or to a conveyor (not shown), onto which the individual tubular articles obtained from cutting a tube T, formed continuously around the spindle 4 as described hereunder, are unloaded. The cutting system which divides the tube T into sections is not shown and is known.

To form the tube T, two strips of cardboard or other continuous web material indicated with S1 and S2 are fed to the corewinder. These are wound helically around the spindle 4 with the aid of a continuous belt 7 having two branches 7A and 7B, driven around two pulleys 9 and 17, the respective axes of rotation of which are indicated with 9A and 17A. The branch 7A forms a helical turn around the spindle 4 and around the strips of web material S1 and S2 in the winding phase. One of the two pulleys 9, 17 is motorized with a motor, not shown.

Inclination of the assembly formed of the pulleys 9, 17, of the belt 7 and of the motor is adjustable in a known way, so as to allow adjustment of the inclination of the helical turns formed by the two strips S1, S2 about the axis of the spindle 4.

The two strips S1 and S2 are wound overlapping and staggered, so that a helix formed of the turns of the outermost strip S1 overlaps a helix formed by the turns of the innermost strip S2. The two turns are staggered so that the joining lines between adjacent turns of the innermost helix are covered by the turns of the outermost strip. By way of example, the two strips can be staggered by half a step.

In the example shown, a glue is applied, in a known way, to the inner surface of the outermost strip S1 and/or to the outer surface of the innermost strip S2, so that the two turns adhere to each other. A glue dispensing unit is indicated schematically with 8, which in the case schematized in the figure applies glue to the inner surface of the strip S1.

As mentioned above, the width of the belt 7 is advantageously less than the width of the strips S1, S2, to prevent it from being soiled with glue.

The strips S1, S2 can be composed of cardboard, with a grammage ranging, for example, from 50 to 300 g/m².

In the example shown in FIG. 1, along the extension of the spindle 4, positioned upstream of the winding member of the strips S1, S2, formed by the belt 7, is a pressure member indicated as a whole with 31, comprising an ultrasonic generator, also called sonotrode 33. The end of the sonotrode, from which the ultrasonic waves are generated, is adjacent to the outer strip S1 of the tube T being formed and is preferably pressed with a certain degree of force against the outer surface thereof. The distance between the surface of the sonotrode 33 and the surface of the forming spindle 4 can be set appropriately and during operation the sonotrode vibrates around a mean position defined by this distance.

The sonotrode and operation thereof are known. For example, an ultrasonic generator of the type described in EP-B-790888 can be used.

The sonotrode 33 generates pressure waves which propagate towards the spindle 4. For greater efficiency, this can have (at least in the area in which the sonotrode acts) a surface machined with raised protuberances, as shown schematically in FIG. 5, where said protuberances are indicated with 4P. The raised area can extend helically with an inclination substantially equivalent to the inclination of the strips forming the tube, to facilitate feed of the tube being formed. The active surface of the sonotrode can be smooth and optionally, curved to follow the shape of the outer surface of the tube being formed.

In a modified embodiment, the sonotrode can have an active surface provided with protuberances, while the spindle is smooth. The protuberances on the sonotrode generate areas of concentrated action in the same way as obtained with the protuberances 4P on the spindle.

The sonotrode 33 can vibrate at a frequency ranging from 15 to 50 kHz.

The pressure waves compress the material of which the strips S1 and S2 are formed, to reinforce the effect of the glue and, if necessary, add to the adhesion obtained by the glue a ply-bonding effect determined by the action of the pressure on the fibrous structure of the strips S1, S2 when they are composed (as is typically the case) of a paper material.

In FIG. 2, where the same numbers indicate identical or,equivalent parts to those in FIG. 1, the sonotrode or ultrasonic generator 33 is positioned downstream of the belt 7 and, for reasons concerning overall dimensions, is over rather than under the axis of the spindle 4. In this figure the glue dispenser 8 is omitted, as it may not be provided when reciprocal adhesion of the strips S1, S2 is entrusted solely to the action of the ultrasonic waves. Nonetheless, the glue dispenser could be present also in this configuration.

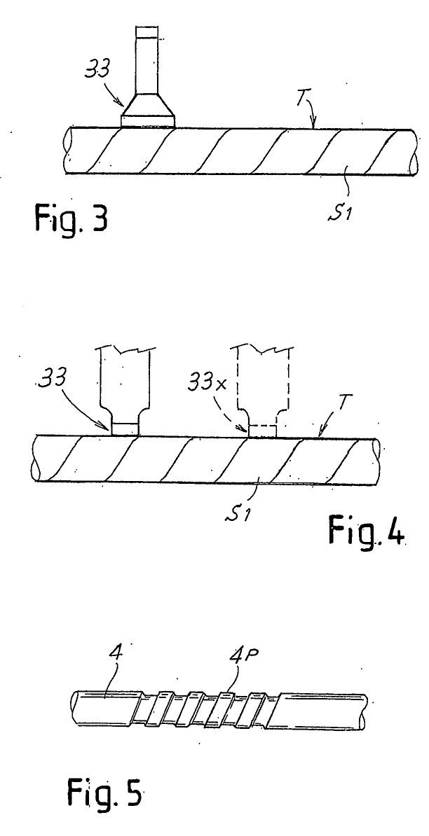

FIGS. 3 and 4 show two possible conformations of the sonotrode 33. In these figures the sonotrode is shown positioned over the forming spindle as in FIG. 2, but it must be understood that it can also be positioned under said spindle, as shown in the diagram in FIG. 1, or in another suitable position, such as on a horizontal plane containing the axis of the spindle, compatibly with the overall dimensions and available spaces. It would also be possible to position several sonotrodes with different orientations about the axis of the spindle 4, if necessary also in different points along the axial extension of said spindle.

In FIG. 3 the sonotrode 33 has an emitting surface of the same width as the outermost strip S1 and exerts pressure on the entire width of the helix.

In FIG. 4 the sonotrode 33 has a smaller emitting surface and is positioned to act at the level of a band of action adjacent to one of the edges of the strip S1 which is wound helically around the spindle 4. A broken line shows a second sonotrode 33X, identical to the sonotrode 33 and positioned to concentrate its action along the other edge of the same strip S1.

With the arrangement described hereinbefore, the corewinder operates as follows. The strips S1, S2 are fed continuously and wound around the spindle 4, which can be a fixed spindle or mounted idle to rotate about the axis thereof. Alternatively and in a known way, the spindle can be partly fixed and partly idle. The staggered turns formed by the two strips S1, S2 are pressed against each other by the belt 7 to stabilize reciprocal gluing of the strips wound in a spiral and form the continuous tube T. This is fed according to the arrow fT rotating about itself towards the cutting means positioned along the path of the tube and not shown, to be cut into sections of the required length. When the tube T passes through the pressure member 31, the pressure waves of the sonotrode 33 produce reciprocal compression of the strips with the effect of improving reciprocal adhesion (or, in the absence of glue dispenser 8, they produce the only effect of reciprocal joining of the strips), to obtain increased stability and strength of the tubular article.

According to an advantageous embodiment, one or other or both the strips S1, S2 can be dampened, for example with water, before winding. The humidity promotes the action of the ultrasonic waves. One or both strips can also be dampened, for example, by the glue, which advantageously can be water-based. If the corewinder is devoid of a glue applicator, it can be provided with a dampening system, such as a nozzle, a roller or the like.

The use of ultrasonic waves in combination with glue can have the further advantage of using water-based rather than synthetic-based glues. Synthetic-based glues are currently used because water-based glues do not have sufficient gluing power. Nonetheless, synthetic glues are more costly, more polluting and difficult to dispose of. In combination with ultrasonic waves, water-based glues could suffice.

It is understood that the drawing merely shows a practical embodiment of the invention, which may vary in forms and arrangements without however departing from the scope of the concept on which the invention is based. Any reference numbers in the attached claims are provided for the sole purpose of facilitating reading in the light of the description hereinbefore and of the accompanying drawings, and do not in any way limit the scope of protection.

1-19. (canceled)

20. A machine for producing a tubular article by helically winding strips of web material, comprising: a spindle; a winding member to helically wind at least two strips of web material, staggered and overlapping each other, around said spindle; and at least one ultrasonic generator positioned to act on the strips being wound around the spindle; wherein said ultrasonic generator is constructed and arranged to exert a pressure on the strips wound, to generate a localized compression on the strips, said compression causing or enhancing reciprocal adhesion of the strips.

21. Machine as claimed in claim 20, further comprising a dampening device to dampen at least one of said strips to promote action of ultrasonic waves generated by said ultrasonic generator.

22. Machine as claimed in claim 21, wherein said machine is constructed and arranged in absence of a glue applicator.

23. Machine as claimed in claim 21, wherein said dampening device applies water to at least one strip of said at least two strips.

24. Machine as claimed in claim 22, wherein said dampening device applies water to at least one strip of said at least two strips.

25. Machine as claimed in claim 20, wherein said ultrasonic generator is arranged to generate localized pressure which causes breakage of fibers of and localized joining of said at least two strips through reciprocal penetration of fibers of at least a first strip in those of a second strip of said at least two strips.

26. Machine as claimed in claim 20, wherein said ultrasonic generator is positioned so as to press on an outermost strip being wound around said spindle.

27. Machine as claimed in claim 20, further comprising a glue dispenser arranged to apply glue to at least one face of a first strip of said at least two strips.

28. Machine as claimed in claim 20, wherein said ultrasonic generator is positioned to act on an area adjacent to edges of a first strip or of a second strip of said at least two strips.

29. Machine as claimed in claim 20, wherein said ultrasonic generator is positioned to act on an area adjacent edges of an outermost strip of said at least two strips.

30. Machine as claimed in claim 20, wherein said spindle has raised areas structured to concentrate effect of ultrasonic waves produced by said ultrasonic generator.

31. Machine as claimed in claim 30, wherein said raised areas extend helically, with a common inclination as an inclination of the strips of web material wound on the spindle.

32. Method for producing tubes formed by helically winding strips of web material, comprising winding at least a first strip and a second strip in an overlapping and staggered manner around a winding spindle, and joining together said at least a first strip and a second strip by applying ultrasonic waves thereto in a manner such that said ultrasonic waves generate a localized compression on the at least a first strip and a second strip to produce or increase reciprocal adhesion.

33. Method as claimed in claim 32, wherein said reciprocal adhesion is produced in absence of application of glue.

34. Method as claimed in claim 32, further comprising dampening at least one of said first strip or said second strip before said winding to dampen said first strip or said second strip and promote action of said ultrasonic waves.

35. Method as claimed in claim 33, further comprising dampening at least one of said first strip or said second strip before said winding to dampen said first strip or said second strip and promote action of said ultrasonic waves.

36. Method according to claim 34, wherein said first strip or said second strip is dampened with water.

37. Method according to claim 35, wherein said first strip or said second strip is dampened with water.

38. Method as claimed in claim 32, further comprising applying glue to at least one face of said first strip or said second strip, said glue causing reciprocal adhesion of at least said first strip or said second strip and the ultrasonic waves increasing effect of said glue by adding localized pressure promoting and consolidating adhesion of said at least said first strip and said second strip.

39. Method as claimed in claim 32, wherein said applying of the ultrasonic waves is concentrated in areas adjacent to edges of at least said first strip or said second strip.

40. Method as claimed in claim 39, wherein said applying of said ultrasonic waves is concentrated On an area adjacent edges of an outermost strip of at least said first strip or said second strip.

41. Method as claimed in claim 32, wherein effect of the ultrasonic waves is concentrated providing raised areas on the winding spindle.

42. Method as claimed in claim 34, wherein said dampening is with a glue containing water.

43. Method as claimed in claim 35, wherein said dampening is with a glue containing water.

44. Method as claimed in claim 32, further comprising applying a water-based glue to at least said first strip or said second strip.
